(19) United States
(12) Patent Application Publication
(10) Pub. No.: US 2026/0159185 A1
(43) Pub. Date: Jun. 11, 2026

(54) TRACK ATTACHMENT/DETACHMENT APPARATUS

(71) Applicant: HANWHA AEROSPACE CO., LTD., Changwon-si (KR)

(72) Inventors: Hee Hyun JEONG, Changwon-si (KR); Nam Hoon Kim, Changwon-si (KR); Jae Kyun Sohn, Changwon-si (KR); Ji Hoon Kong, Changwon-si (KR)

(73) Assignee: HANWHA AEROSPACE CO., LTD., Changwon-si (KR)

(21) Appl. No.: 19/180,913

(22) Filed: Apr. 16, 2025

(30) Foreign Application Priority Data
Dec. 6, 2024 (KR) 10-2024-0180555

(51) Int. Cl. B62D 55/32; B23P 19/04

(52) U.S. Cl. CPC B62D 55/32; B23P 19/04

(57) ABSTRACT

A track attachment and detachment apparatus may include: an upper support configured to support a an upper region of a track of a vehicle; a lower support configured to support a lower region of the track while extending in parallel to the upper support; a plurality of side supports configured to maintain a gap between the upper support and the lower support; a first angle adjuster configured to support a first inclined portion of the track while the first angle adjuster has a first inclination angle, the first angle adjuster further configured to selectively set the first inclination angle to correspond to a side of a drive wheel of the vehicle; and a first presser configured to press the track in a first pressing direction toward the drive wheel from the upper support such that the track is separated from the drive wheel.

### CROSS-REFERENCE TO RELATED APPLICATION

This application claims priority from Korean Patent Application No. 10-2024-0180555, filed on Dec. 6, 2024, in the Korean Intellectual Property Office, and all the benefits accruing therefrom under 35 U.S.C. 119, the disclosure of which in its entirety is herein incorporated by reference.

### BACKGROUND

### 1. Field

Some embodiments of the present disclosure relate to a track attachment and detachment apparatus, and more particularly, to a track attachment and detachment apparatus that facilitates movement and transportation and enables tracks to be easily attached and detached with minimal manpower.

### 2. Description of Related Art

Generally, composite rubber tracks have advantages over steel tracks in terms of weight, noise, vibration, and maintenance.

Rubber tracks, which may be approximately 40% lighter than steel tracks, allow for the installation of additional armament or protective equipment, thereby improving crew survivability. Reduced noise and vibration also enhance survivability against adversaries while reducing crew fatigue. Furthermore, in terms of maintenance, there is no need for tasks such as pad replacement and preventive maintenance, leading to reduced maintenance costs.

Equipment that can apply composite rubber tracks includes all vehicles that use tracks, such as tanks, self-propelled guns, and armored vehicles. Recently, rubber tracks have been introduced and used in Redbacks, Australian export armored vehicles.

Existing rubber track replacement devices are applicable to equipment such as light armored vehicles (e.g., approximately 15-ton class), where the tracks weigh about 400 kg. These lighter tracks can be replaced in two methods.

First, the replacement can be performed manually by 2 to 3 personnel. Second, a replacement device can be directly installed on the vehicle body. However, since installing the replacement device on the vehicle body raises concerns about potential damage to the vehicle body, and manual replacement is more advantageous in terms of economic efficiency and time, the first method is used.

These methods used for light armored vehicles cannot be applied to heavier armored vehicles such as 47-ton class Redbacks. This is because the tracks alone weigh approximately 1,200 kg, making it impossible to move or lift manually. Moreover, installing a replacement device on the vehicle body can cause significant and unavoidable damage.

Therefore, a replacement device has been developed for heavy infantry fighting vehicles (HIFVs) such as Redbacks. However, the replacement device is large (e.g., 5.5 m in size) and heavy (e.g., 2 tons), so it can only be used in maintenance depots or factories equipped with cranes. Furthermore, replacing tracks with this device takes a significant amount of time (e.g., over 12 hours). These various issues impose many limitations on transporting the device to the field for rubber track maintenance. Simulation results show that at least two 5-ton trucks, one forklift, and a minimum of four personnel are required. Additionally, the numerous components in the device result in excessive repair costs and preventive maintenance demands, complicating maintenance.

### SUMMARY

According to embodiments of the present disclosure, a track attachment and detachment apparatus may be provided that facilitates movement and transportation and enables tracks to be easily attached and detached with minimal manpower.

According to some embodiments of the present disclosure, a track attachment and detachment apparatus may be provided and include: an upper support configured to support a lower part of an upper region of a track of a vehicle, the lower part of the upper region of the track being above the upper support; a lower support configured to support a lower part of a lower region of the track while extending in parallel to the upper support; a plurality of side supports configured to maintain a gap between the upper support and the lower support; a first angle adjuster configured to support a first inclined portion of the track while the first angle adjuster has a first inclination angle from the lower support toward the upper support, the first angle adjuster further configured to selectively set the first inclination angle to correspond to a side of a drive wheel of the vehicle, the drive wheel configured to receive a first driving force of the vehicle; and a first presser configured to press the track in a first pressing direction toward the drive wheel from the upper support such that the track is separated from the drive wheel.

According to one or more embodiments of the present disclosure, the first angle adjuster includes: a support frame extending along a longitudinal direction of the lower support at a first side of the lower support; a rotating frame, wherein a first end of the rotating frame is configured to be hinge-coupled to the support frame and a second end of the rotating frame is configured to rotate to correspond to an inclination angle of the track; and an angle adjuster configured to be connected to and between the support frame and the second end of the rotating frame, and vary in length to adjust an inclination angle of the rotating frame.

According to one or more embodiments of the present disclosure, the first angle adjuster further includes a friction contact between the rotating frame and the first inclined portion of the track, wherein the friction contact is configured to make frictional contact with an outer surface of the track.

According to one or more embodiments of the present disclosure, the friction contact includes: a fixing plate configured to be fixed to an upper surface of the rotating frame; and a plurality of friction patterns protruding from the fixing plate and configured to be respectively inserted into a plurality of treads on the outer surface of the track.

According to one or more embodiments of the present disclosure, the first angle adjuster further includes a spacing adjuster configured to slide the fixing plate relative to the rotating frame along a longitudinal direction of the rotating frame.

According to one or more embodiments of the present disclosure, the first angle adjuster further includes an inclination angle indicator that indicates an inclination angle set for a type of the vehicle.

According to one or more embodiments of the present disclosure, the first presser includes: a moving frame configured to be inserted into, and slidably movable within, a first end of the upper support; a driver at the first end of the upper support and configured to provide a second driving force that causes the moving frame to move linearly back and forth; and a head unit including an adjustment bar, the head unit being at a leading end of the moving frame, and the adjustment bar protruding in a direction perpendicular to the moving frame, the adjustment bar configured to physically interact with a guide lug at an inner center of the track.

According to one or more embodiments of the present disclosure, the first presser is configured to separate the track from the drive wheel by pressing the track in a direction toward the drive wheel.

According to one or more embodiments of the present disclosure, a cross-section of the adjustment bar includes a circular shape or a polygonal shape.

According to one or more embodiments of the present disclosure, the first presser further includes a guide between the moving frame and the first end of the upper support, the guide configured to guide sliding movement of the moving frame.

According to one or more embodiments of the present disclosure, the guide includes: a guide rail, wherein a first side of the guide rail, perpendicular to an extending direction of the guide rail, faces towards the moving frame; and a block coupled to a second side of the guide rail, opposite to the first side of the guide rail, wherein the block is configured to enable rolling movement of the guide rail.

According to one or more embodiments of the present disclosure, the driver includes: a screw shaft, wherein an end of the screw shaft is configured to be connected to a lower part of the moving frame to move the moving frame linearly; a case at the first end of the upper support, the case configured to allow the screw shaft to move linearly in and out of the case due to a rotational force; and a handle configured to input the rotational force to the case, based on a user interacting with the handle.

According to one or more embodiments of the present disclosure, the track attachment and detachment apparatus further includes a second presser configured to provide a pressing force to the track in a direction opposite to the first pressing direction.

According to one or more embodiments of the present disclosure, the track attachment and detachment apparatus further includes a second angle adjuster configured to support a second inclined portion of the track while the second angle adjuster has a second inclination angle from the lower support toward the upper support, the second angle adjuster further configured to selectively set the second inclination angle to correspond to a side of an idler wheel of the vehicle, wherein the drive wheel is at a first side of the track, and the idler wheel is at a second side of the track, opposite to the first side of the track.

According to one or more embodiments of the present disclosure, the upper support includes: a first frame configured to support the track in a first support groove of the track while the first frame extends along a longitudinal direction of the track, the first support groove being between a guide lug of the track and a first drive lug of the track; a second frame that extends parallel the first frame below the first frame; a pair of fork frames that extend between the first frame and the second frame, in a direction perpendicular to the longitudinal direction of the track, the pair of fork frames configured to receive forks of a forklift; and at least one auxiliary support structure that includes: a third frame that extends perpendicular to the first frame, between the first frame, the second frame, and the pair of fork frames; a fourth frame that extends parallel to the first frame at a first side of the third frame, the fourth frame configured to support the track in a second support groove of the track, the second support groove being between the guide lug and a second drive lug of the track; and a fifth frame coupled to an upper end of one of the plurality of side supports at a second side of the third frame, opposite to the first side of the third frame.

According to one or more embodiments of the present disclosure, the upper support further includes a release pin configured to detachably couple the fifth frame and the one of the plurality of side supports.

According to one or more embodiments of the present disclosure, the upper support further includes a first extension frame and a second extension frame that are configured to be connected to respective ends of the first frame such that the first frame, the first extension frame, and the second extension frame are at a same height.

According to one or more embodiments of the present disclosure, the first presser is configured to be detachably connected to a leading end of the first extension frame at a first side of the first frame, wherein the track attachment and detachment apparatus further includes a second presser configured to provide a pressing force to the track in a second pressing direction opposite to the first pressing direction, wherein the second presser is configured to be detachably connected to a leading end of the second extension frame at a second side of the first frame, opposite to the first side of the first frame, and wherein the at least one auxiliary support structure includes: a first auxiliary support structure connected to the first extension frame; and a second auxiliary support structure connected to the second extension frame.

According to one or more embodiments of the present disclosure, the lower support includes: sixth frames arranged along a longitudinal direction of the track to support a lower side of the lower region of the track; and seventh frames below the sixth frames, the seventh frames extending in a direction perpendicular to the sixth frames.

According to one or more embodiments of the present disclosure, the lower support further includes: a first unit support structure including a first set of the sixth frames and a first set of the seventh frames, the first unit support structure configured to be on a first side of the lower region of the track; and a second unit support structure including a second set of the sixth frames and a second set of the seventh frames, the second unit support structure on a second side of the lower region of the track, opposite to the first side of the lower region of the track, and wherein the first unit support structure and the second unit support structure are configured to be detachably coupled to each other.

The track attachment and detachment apparatus according to an embodiment of the present disclosure may provide the following advantages.

First, the attachment and detachment of tracks can be performed quickly with minimal personnel and equipment.

Second, by configuring the track attachment and detachment apparatus as an assembly structure, it can be loaded onto a single vehicle, enabling rapid maintenance regardless of the maintenance location.

Third, the track attachment and detachment apparatus enables the quick release of the strong pressure that keeps the track engaged around a drive wheel.

Aspects and effects of embodiments of the present disclosure are not limited to the aspects and effects mentioned above, and other aspects and effects not explicitly stated will be clearly understood by those skilled in the art based on the following description.

### BRIEF DESCRIPTION OF DRAWINGS

The following detailed description and the summary above will be better understood when read in conjunction with the accompanying drawings. The drawings illustrate non-limiting embodiments for purposes of example. However, it should be understood that the present disclosure is not limited to the precise arrangements and means illustrated.

FIG. 1 is a side view illustrating a vehicle equipped with rubber tracks.

FIG. 2 is a perspective view illustrating a state where a track attachment and detachment apparatus according to an embodiment of the present disclosure is installed on a track.

FIG. 3 is a perspective view illustrating an upper support module of the track attachment and detachment apparatus of FIG. 2.

FIG. 4 is a cross-sectional view of the track attachment and detachment apparatus of FIG. 2 along a line A-A′.

FIG. 5 is a perspective view illustrating a first pressing module of the track attachment and detachment apparatus of FIG. 2.

FIG. 6 is an exploded perspective view illustrating a first pressing module of the track attachment and detachment apparatus of FIG. 5.

FIG. 7 is a reference diagram illustrating a state before the first pressing module of the track attachment and detachment apparatus of FIG. 5 is operated while being mounted on a track.

FIG. 8 is a perspective view illustrating a state where the first pressing module of the track attachment and detachment apparatus of FIG. 5 is operated.

FIG. 9 is a reference diagram illustrating a state where the first pressing module of the track attachment and detachment apparatus of FIG. 8 is operated while being mounted on the track.

FIG. 10 is a perspective view illustrating a lower support module of the track attachment and detachment apparatus of FIG. 2.

FIG. 11 is a perspective view illustrating a first angle adjustment module of the track attachment and detachment apparatus of FIG. 10.

FIG. 12 is an exploded perspective view illustrating the first angle adjustment module of the track attachment and detachment apparatus of FIG. 11.

FIG. 13 is a reference diagram illustrating a state where the track is seated on the first angle adjustment module of the track attachment and detachment apparatus of FIG. 11.

FIG. 14 is a perspective view illustrating a side support module of the track attachment and detachment apparatus of FIG. 2.

FIG. 15 is a reference diagram illustrating a process of coupling the side support module and the upper support module of the track attachment and detachment apparatus of FIG. 14.

FIG. 16 is a perspective view illustrating a release pin that connects the side support module and the upper support module of the track attachment and detachment apparatus of FIG. 15.

### DETAILED DESCRIPTION

Non-limiting example embodiments of the present disclosure will hereinafter be described in detail with reference to the accompanying drawings. Advantages, features, and methods for achieving the same in the present disclosure will become apparent by referring to the example embodiments described below along with the accompanying drawings. However, embodiments of the present disclosure are not limited to the example embodiments set forth below and may be implemented in various other forms. The following example embodiments are provided to o fully convey the scope of the present disclosure to those skilled in the art. Throughout the specification, the same reference numerals denote the same components.

Embodiments of the present disclosure can undergo various modifications, and specific non-limiting example embodiments will be illustrated in the drawing and described below. However, the present disclosure is not limited to such specific example embodiments, and it should be understood to include all modifications, equivalents, and alternatives within the spirit and scope of the present disclosure.

Terms including ordinal numbers such as “first,” “second,” etc., may be used to describe various components, but these components are not limited by these terms. These terms are used only to distinguish one component from another. For example, a second component can be named a first component without departing from the scope of the present disclosure, and similarly, a first component can be named a second component.

The term “and/or” includes any combination of one or more of the associated listed items or any of the listed items individually.

When a component is said to be “connected to” or “coupled to” another component, it may be directly connected or coupled to the other component, or intervening components may be present. Conversely, when a component is said to be “directly connected to” or “directly coupled to” another component, there are no intervening components.

The terms used in this application are for the purpose of describing particular example embodiments only and are not intended to limit the present disclosure.

Unless the context clearly indicates otherwise, the singular forms include the plural forms as well.

In this application, the terms “comprising,” “including,” and “having” are intended to specify the presence of stated features, numbers, steps, operations, elements, components, or combinations thereof, but do not preclude the presence or addition of one or more other features, numbers, steps, operations, elements, components, or combinations thereof.

Non-limiting example embodiments will hereinafter be described with reference to the accompanying drawings, wherein the same or corresponding components, regardless of the drawing numbers, are assigned the same reference numbers, and redundant descriptions may be omitted.

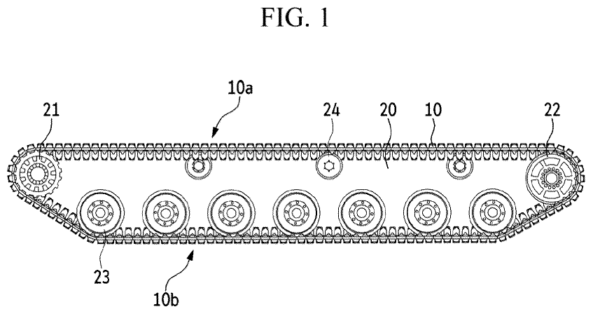

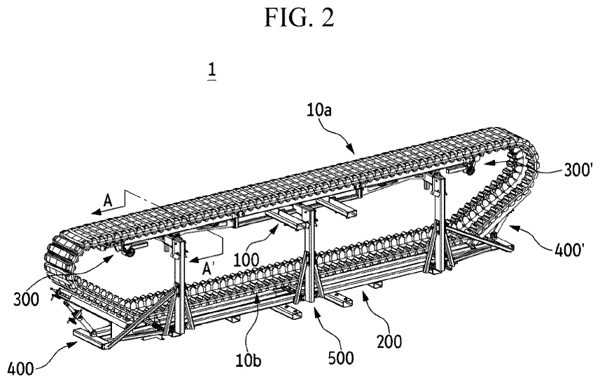

FIG. 1 is a side view illustrating a vehicle equipped with rubber tracks, and FIG. 2 is a perspective view illustrating a state where a track attachment and detachment apparatus according to an embodiment of the present disclosure is installed on a track.

Referring to FIGS. 1 and 2, in embodiments of the present disclosure, a vehicle may correspond to an armored vehicle 20 that drives using a track 10.

The track 10 of the vehicle may be coupled to rotate repeatedly through a driving force transmitted to a drive wheel 21 disposed on one upper side of the vehicle. In addition, an idler wheel 22 may be provided on the other upper side of the vehicle, and a plurality of bogie wheels 23 may be provided on a lower side of the vehicle between the drive wheel 21 and the idler wheel 22. The track 10 may be arranged such that an upper region 10a of the track 10 may be positioned between the drive wheel 21 and the idler wheel 22, and a lower region 10b of the track 10 may be in contact with the bogie wheels 23. The vehicle may also be provided with a plurality of support wheels 24 that support the center of the upper region 10a of the track 10 between the drive wheel 21 and the idler wheel 22.

A track attachment and detachment apparatus 1 according to an embodiment of the present disclosure may include an upper support module 100 (e.g., an upper support) that supports a lower part of the upper region 10a of the track 10, a lower support module 200 (e.g., a lower support) that supports a lower part of the lower region 10b of the track 10, a first pressing module 300 (e.g., a first presser) that presses the track 10 at the upper support module 100, a first angle adjustment module 400 (e.g., a first angle adjuster) that supports one inclined surface of the track 10 at the lower support module 200, and a side support module 500 (e.g., a side support) that maintains a constant gap between the upper support module 100 and the lower support module 200.

The upper support module 100 and the lower support module 200 may extend parallel to each other along the longitudinal direction of the track 10. In addition, the side support module 500 may extend in a top-bottom direction to perpendicularly intersect the upper support module 100 and the lower support module 200.

Also, the first angle adjustment module 400 may support an inclined portion of the track 10 while maintaining an inclination angle with respect to one side of the lower support module 200 toward the upper support module 100, corresponding to the inclination angle formed between the drive wheel 21 and the adjacent bogie wheel 23 on one side of the lower region 10b of the track 10. Additionally, the first angle adjustment module 400 may first perform a process of adjusting the inclination angle to support the inclined portion of the track 10 before the first pressing module 300, which will be described later, is operated.

A second angle adjustment module 400′ (e.g., a second angle adjuster) may provide an inclination angle with respect to the other side of the lower support module 200 toward the upper support module 100, corresponding to an inclination angle formed between the idler wheel 22 and the adjacent bogie wheel 23 on the other side of the lower region 10b of the track 10.

The second angle adjustment module 400′ may provide the same function and effect as the first angle adjustment module 400 when attaching or detaching a track 10 on the other side of the vehicle, other than the track 10 provided on the one side of the vehicle. For example, the track attachment and detachment apparatus 1 may rotate 180 degrees from the track 10 to move to another one of the tracks 10, and the second angle adjustment module 400′ performs the same function as the first angle adjustment module 400 during the process of attaching or detaching the other one of the tracks 10.

The detailed configuration of the upper support module 100 and the structure supporting the track 10 will hereinafter be described in detail.

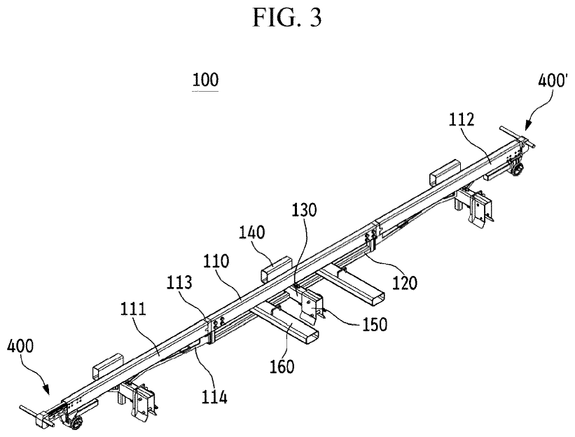

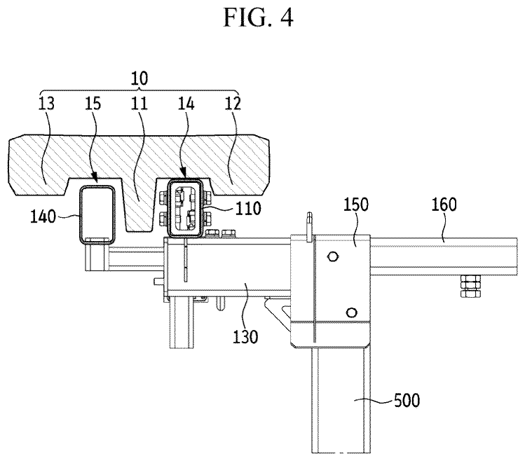

FIG. 3 is a perspective view illustrating the upper support module of the track attachment and detachment apparatus of FIG. 2, and FIG. 4 is a cross-sectional view of the track attachment and detachment apparatus of FIG. 2 along a line A-A′.

Referring to FIGS. 3 and 4, the upper support module 100 may include a first frame 110, a second frame 120, a third frame 130, and a fourth frame 140, and a fifth frame 150.

The first frame 110 may support the lower side of the upper region 10a along the longitudinal direction of the track 10. The upper surface of the first frame 110 may support the track 10 by being arranged in a first support groove 14 of the track 10, which may be formed between a plurality of guide lugs 11 protruding (e.g., downwards) along the inner center of the track 10, with respect to a width direction of the track 10, and a plurality of first drive lugs 12 disposed on one side (e.g., the outer side) of the guide lugs 11 in the width direction of the track 10.

In addition, the second frame 120 may be arranged (e.g., may extend) parallel to the lower part of the first frame 110.

Additionally, the third frame 130 may be arranged perpendicular to the first frame 110, between the first frame 110 and the second frame 120 in a vertical direction. The third frame 130 may be arranged such that both ends of the third frame 130 protrude beyond the width of the first frame 110. For example, one side of the third frame 130 may be further than a corresponding side of the first frame 110 in a first horizontal direction (e.g., the width direction), and another side of the third frame 130 may be further than a corresponding other side of the first frame 110 in a second horizontal direction, opposite to the first horizontal direction.

Moreover, the fourth frame 140 may be arranged (e.g., extend) parallel to the first frame 110 at one leading end of the third frame 130. The upper surface of the fourth frame 140 may support the track 10 by being arranged in a second support groove 15 of the track 10, which may be formed between the guide lugs 11 and a plurality of second drive lugs 13 disposed on the other side (e.g., the inner side) of the guide lugs 11 in the width direction of the track 10. Therefore, the first frame 110 and the fourth frame 140 can support the track 10 in a balanced manner around the guide lugs 11 in the width direction of the track 10.

Furthermore, the fifth frame 150 may be coupled to an upper end of the side support module 500 at the other leading end of the third frame 130.

Additionally, fork frames 160 may be provided on both sides of the third frame 130 in a length direction, between the first frame 110 and the second frame 120 in the vertical direction. When moving the upper support module 100 or the entire track attachment and detachment apparatus 1, the fork frames 160 may be used for towing, with forklift forks inserted in the fork frames 160.

Also, extension frames may be coupled to both ends of the first frame 110 in the length direction. For example, a first extension frame 111 may be coupled to one side of the first frame 110, and a second extension frame 112 may be coupled to the other side of the first frame 110. Each of the first extension frame 111 and the second extension frame 112 may support the track 10 with an upper surface of the first extension frame 111 and the second extension frame 112 formed at the same height as an upper surface of the first frame 110. For transport or storage, the first extension frame 111 and the second extension frame 112 may be separated from the first frame 110. Couplers 113 may be provided between the first frame 110 and the first extension frame 111, and the first frame 110 and the second extension frame 112, to securely couple the first frame 110 to both the first extension frame 111 and the second extension frame 112.

Reinforcing frames 114 may be provided below the first extension frame 111 and the second extension frame 112 to support the first extension frame 111 and the second extension frame 112 while being coupled to or in close contact with both ends of the second frame 120, respectively.

According to some embodiments of the present disclosure, the upper support module 100 may include a plurality of auxiliary support structures, and each of the auxiliary support structure may include a set of the third frame 130, the fourth frame 140, and the fifth frame 150. For example, a first auxiliary support structure from among the auxiliary support structures may be connected to a bottom of the first extension frame, a second auxiliary support structure from among the auxiliary support structures may be connected to a bottom of the first frame, and a third auxiliary support structure from among the auxiliary support structures may be connected to a bottom of the second extension frame 112.

The structure of the first pressing module 300 of FIG. 3 will hereinafter be described in detail.

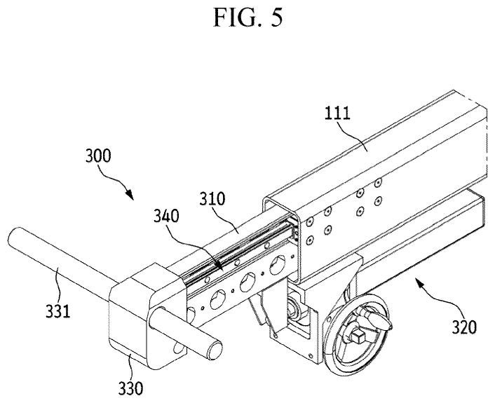

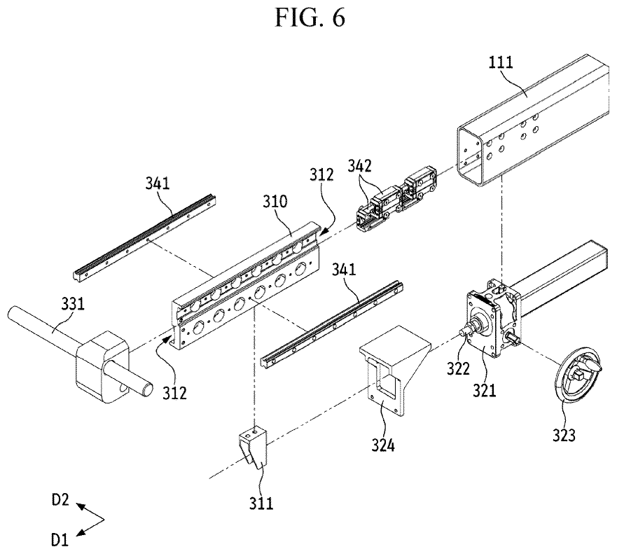

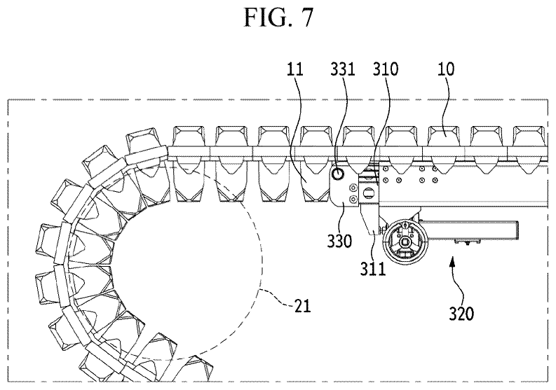

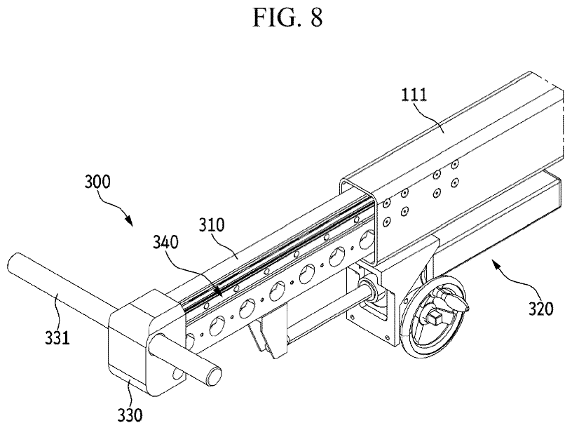

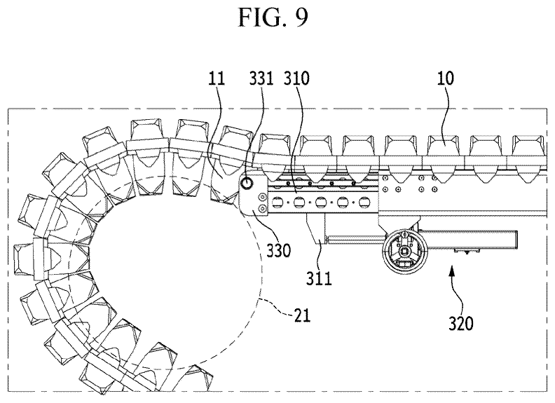

FIG. 5 is a perspective view illustrating the first pressing module of the track attachment and detachment apparatus 1 of FIG. 2, FIG. 6 is an exploded perspective view illustrating the first pressing module of the track attachment and detachment apparatus of FIG. 5, FIG. 7 is a reference diagram illustrating a state before the first pressing module of the track attachment and detachment apparatus of FIG. 5 is operated while being mounted on a track, FIG. 8 is a perspective view illustrating a state where the first pressing module of the track attachment and detachment apparatus of FIG. 5 is operated, and FIG. 9 is a reference diagram illustrating a state where the first pressing module of the track attachment and detachment apparatus of FIG. 8 is operated while being mounted on the track.

Referring to FIGS. 5 through 9, the first pressing module 300 may be mounted at the leading end of the first extension frame 111 described above.

The first pressing module 300 may include a moving frame 310, a drive unit 320 (e.g., a driver), and a head unit 330 (e.g., a body).

The moving frame 310 may be slidably coupled to the leading end of the first extension frame 111 of the upper support module 100.

In addition, the drive unit 320 may be disposed below the first extension frame 111 to provide driving force for the moving frame 310 to move linearly back and forth (e.g., in the length direction). For example, the drive unit 320 may include a jack screw structure. Alternatively, a pneumatic or hydraulic cylinder structure may be included in the drive unit 320.

The drive unit 320 may include a case 321, a screw shaft 322, and a handle 323.

The case 321 may convert rotational motion into linear motion at a lower part of the first extension frame 111. The conversion method may be implemented through a gear module of the drive unit 320 such as, for example, a worm and a worm gear. The case 321 may be provided with a separate bracket 324 to couple the case 321 to the lower part of the first extension frame 111. For example, one side of the bracket 324 (e.g., in the length direction) may be coupled to the lower part of the first extension frame 111, and the other side of the bracket 324 (e.g., in the length direction) may be coupled to the case 321.

Also, one end of the screw shaft 322 (e.g., in the length direction) may be connected to a bracket 311 provided below the moving frame 310, and the other end of the screw shaft 322 (e.g., in the length direction) may be arranged to enter and exit the inside of the case 321. The screw shaft 322 may protrude from or retract into the case 321. When the screw shaft 322 protrudes outside the case 321, the leading end of the screw shaft 322 may move the head unit 330 and the moving frame 310 coupled to the head unit 330 forward in a direction D1 (e.g., the length direction).

The handle 323 may be arranged on a side of the case 321 in, for example, the width direction. When a user applies rotational force to the handle 323, the screw shaft 322 may perform linear reciprocating movement as it physically interacts with a gear coupled to the rotational axis of the handle 323.

The head unit 330 may be arranged at the leading end of the moving frame 310 (e.g., in the length direction) and may move simultaneously with the sliding movement of the moving frame 310.

The head unit 330 may include an adjustment bar 331 that protrudes in a direction D2 (e.g., the width direction) perpendicular to the direction D1, which may be the linear movement direction of the moving frame 310. The adjustment bar 331 may be arranged in the groove between (e.g., in the length direction) one guide lug 11 and another adjacent guide lug 11 of the track 10, and may be positioned to physically interact with the guide lug 11 ahead in the movement direction of the moving frame 310. The adjustment bar 331 may be formed with a circular, triangular, or polygonal cross-section. In this embodiment, the adjustment bar 331 is described as having, for example, a circular structure (e.g., a circular cross-section). The adjustment bar 331 may be arranged not to contact the first drive lug 12 or the second drive lug 13 when being in contact with the guide lug 11.

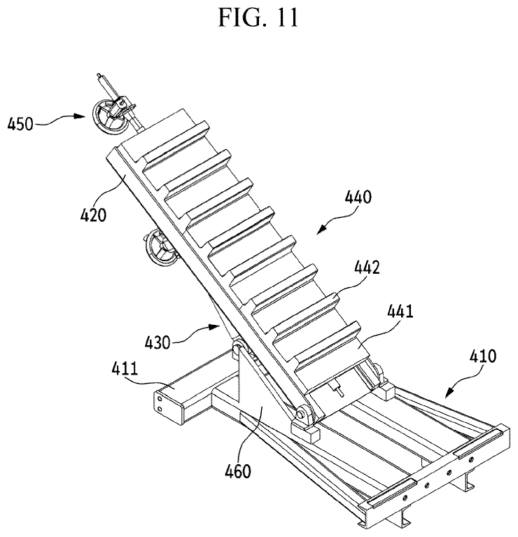

Accordingly, as illustrated in FIG. 9, when the moving frame 310 protrudes from the first extension frame 111, it may press the guide lug 11, causing the upper part of the track 10 adjacent to the drive wheel 21 to bulge outward, thereby inducing separation between the drive wheel 21 and the track 10. At the point where the first pressing module 300 operates, at least some or all of the idler wheel 22, bogie wheels 23, and support wheels 24 may already have been removed. For example, the moving frame 310 may induce the separation by pressing the track 10, starting at a contact region of the track 10 opposite to the fixing plate 441 (see FIG. 11) relative to the drive wheel 21.

A guide unit 340 (e.g., a guide) may be provided between the moving frame 310 and the first extension frame 111 (e.g., in the width direction) to guide the sliding movement of the moving frame 310.

The guide unit 340 may include guide rails 341 and blocks 342.

The guide rails 341 may extend longitudinally along the movement direction (e.g., the length direction) of the moving frame 310 on both sides of the moving frame 310 in, for example, the width direction. Here, to reduce the width or thickness of the moving frame 310, the guide rails 341 may be positioned at different heights relative to the height direction of the moving frame 310. That is, grooves 312 may be formed at positions where the guide rails 341 are coupled. Since the grooves 312 are concavely formed in the width direction of the moving frame 310, the installation width of the moving frame 310 can be minimized by positioning the guide rails 341 at different heights on both sides of the moving frame 310 in the width direction.

In addition, the blocks 342 may include a plurality of bearings to support the guide rails 341 and provide low-friction sliding movement of the guide rails 341 through rolling motion. The blocks 342 may also be arranged inside the first extension frame 111 to correspond to the positions of the guide rails 341. Furthermore, a plurality of blocks 342 may be arranged inside the first extension frame 111 to correspond to the length of the guide rails 341. For example, the guide rails 341 and blocks 342 may include a structure of a linear motion (LM) guide.

Furthermore, a second pressing module 300′, having the same structure as the first pressing module 300, may optionally be provided at the leading end of the second extension frame 112 (see FIGS. 2 and 3). The second pressing module 300′ may be used when detaching the other track 10 that differs from the track 10 in the position of the drive wheel 21. The structure of the second pressing module 300′ may be identical to the structure of the first pressing module 300 except for its position (e.g., on an opposite side of the first frame 110) and pressing direction (e.g., in a direction opposite to the pressing direction of the first pressing module 300), and thus, a repeated description thereof may be omitted.

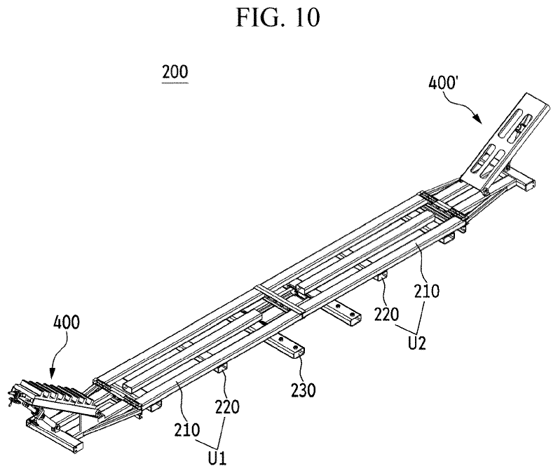

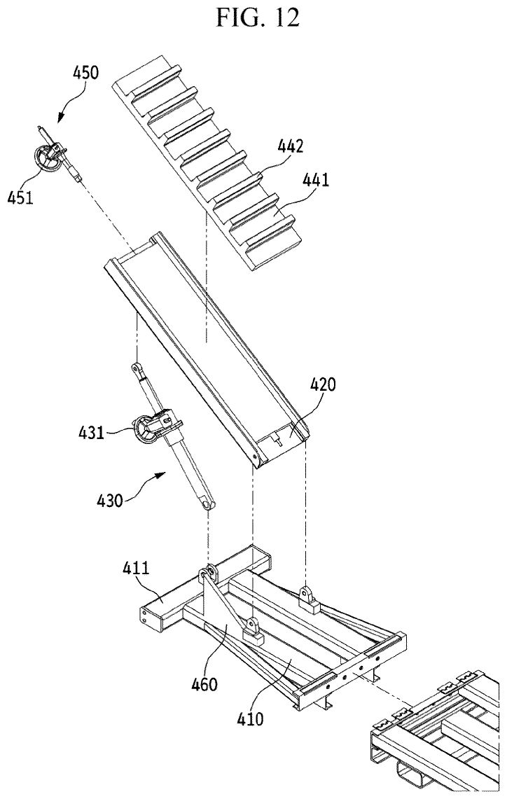

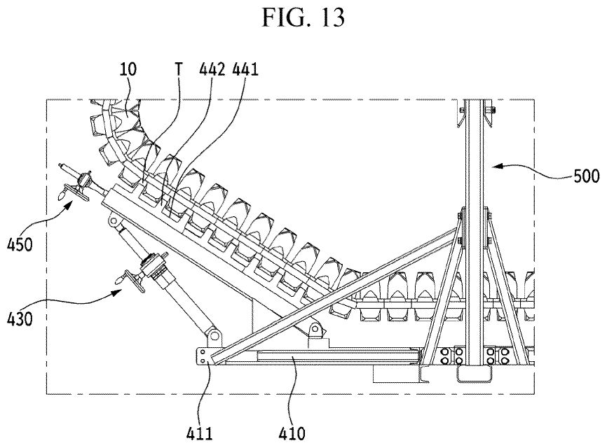

FIG. 10 is a perspective view illustrating the lower support module of the track attachment and detachment apparatus of FIG. 2, FIG. 11 is a perspective view illustrating the first angle adjustment module of the track attachment and detachment apparatus of FIG. 10, FIG. 12 is an exploded perspective view illustrating the first angle adjustment module of the track attachment and detachment apparatus of FIG. 11, and FIG. 13 is a reference diagram illustrating a state where the track is seated on the first angle adjustment module of the track attachment and detachment apparatus of FIG. 11.

Referring to FIGS. 10 through 13, the lower support module 200 may include sixth frames 210 and seventh frames 220.

The sixth frames 210 may be arranged along the longitudinal direction of the track 10 to support the lower side of the lower region 10b of the track 10. A plurality of sixth frames 210 may be provided. The sixth frames 210 may have a plate structure (e.g., a plate shape) rather than a frame structure (e.g., a frame shape).

In addition, the seventh frames 220 may extend perpendicular to the sixth frames 210 and may be arranged below the sixth frames 210. The seventh frames 220 may be coupled to connect the sixth frames 210.

The sixth frames 210 and the seventh frames 220 may form a single unit support structure. On one side (e.g., in the length direction) of the lower region 10b of the track 10 (see FIG. 2), a first unit support structure U1 may be provided, and on the other side (e.g., in the length direction) of the lower region 10b of the track 10, a second unit support structure U2 may be provided. The first unit support structures U1 and the second unit support structures U2 may be detachably coupled to each other relative to the center of the lower region 10b of the track 10. Accordingly, the lower support module 200 may be separated into the first unit support structures U1 and the second unit support structures U2 for transport or storage.

Fork frames 230 may be provided in parallel on the first unit support structure U1 and the second unit support structure U2. Accordingly, the lower support module 200, like the upper support module 100, may also be transported by inserting forklift forks into the fork frames 230.

The first angle adjustment module 400 and the second angle adjustment module 400′ may be disposed at the leading ends (e.g., in the length direction) of the first unit support structure U1 and the second unit support structure U2, respectively. The first angle adjustment module 400 and the second angle adjustment module 400′ may be detachably connected to the leading ends (e.g., in the length direction) of the first unit support structure U1 and the second unit support structure U2.

The first angle adjustment module 400 may be disposed at the leading end (e.g., in the length direction) of the first unit support structure U1, and the second angle adjustment module 400′ may be disposed at the leading end (e.g., in the length direction) of the second unit support structure U2. Since the first angle adjustment module 400 and the second angle adjustment module 400′ may have the same structure and function, only the structure of the first angle adjustment module 400 will be described in detail below.

The first angle adjustment module 400 may include support frames 410, a rotating frame 420, and an angle adjustment unit 430 (e.g., an angle adjuster).

The support frames 410 may be arranged (e.g., may extend) in parallel with the sixth frames 210 at the leading end of the first unit support structure U1. A plurality of support frames 410 may be formed, and an edge frame 411 may be provided at the leading end (e.g., in the length direction) of the support frame 410. The edge frame 411 may be arranged (e.g., may extend) perpendicularly to the support frames 410 to connect the support frames 410. The support frames 410 may be arranged (e.g., may extend) parallel to the lower support module 200 on the installation surface.

In addition, one end (e.g., in the length direction) of the rotating frame 420 may be hinge-coupled to the support frames 410, and the other end (e.g., in the length direction) of the rotating frame 420 may be rotatably arranged to correspond to the inclination angle of the track 10.

One end of the angle adjustment unit 430 may be rotatably connected to the edge frame 411, and the other end of the angle adjustment unit 430 may be connected to the lower surface of the rotating frame 420 to adjust the angle of the rotating frame 420. The angle adjustment unit 430 may be configured as a jack screw structure to convert rotational motion into linear reciprocating motion. Accordingly, when the user rotates a handle 431 of the angle adjustment unit 430 in one direction, the length of the angle adjustment unit 430 may increase, and when the user rotates the handle 431 in the other direction, the length of the angle adjustment unit 430 may decrease.

The first angle adjustment module 400 may include a friction contact unit 440 (e.g., a friction contact) and a spacing adjustment unit 450 (e.g., a spacing adjuster).

The friction contact unit 440 may include a fixing plate 441 and friction patterns 442.

The fixing plate 441 may be arranged on the rotating frame 420 to slide along the longitudinal direction of the rotating frame 420.

In addition, the friction patterns 442 may protrude from the upper surface of the fixing plate 441 toward the outer surface of the track 10 and may be inserted into treads T formed on the outer surface of the track 10. That is, as the friction contact unit 440 moves along the rotating frame 420, the friction patterns 442 may be respectively inserted into the treads T at positions aligned with the track 10.

The spacing adjustment unit 450 may be fixed on the rotating frame 420. When the user rotates the handle 451 in one direction, the fixing plate 441 may move linearly outward along the rotating frame 420, and when the handle 451 is rotated in the other direction, the fixing plate 441 may move linearly inward along the rotating frame 420.

That is, when the track 10 is placed on the friction contact unit 440, the user may rotate the spacing adjustment unit 450 to align the friction patterns 442 with the treads T of the track 10.

The first angle adjustment module 400 may include an inclination angle indicator 460.

The inclination angle indicator 460 may be installed on the support frame 410 and arranged adjacent to the hinge rotation area of one end of the rotating frame 420. The inclination angle indicator 460 may generally have a triangular cross-sectional shape and may allow the user to intuitively check the rotation angle of the rotating frame 420 from the support frame 410. The shape of the inclination angle indicator 460 is not limited to a triangle.

For example, angle indication lines corresponding to the various inclination angles of various vehicle tracks may be displayed on the outer surface of the inclination angle indicator 460. Accordingly, the rotating frame 420 may be adjusted and installed to match the various inclination angles of various vehicle tracks.

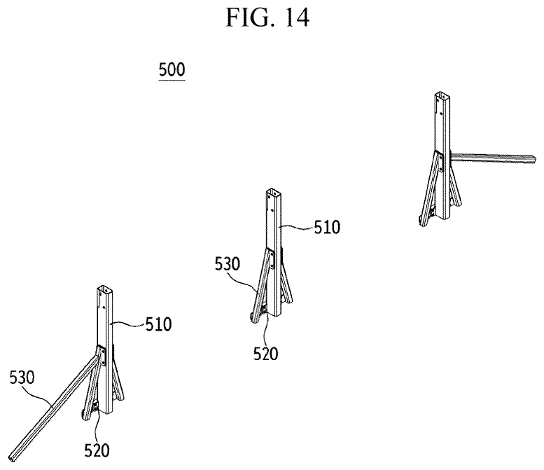

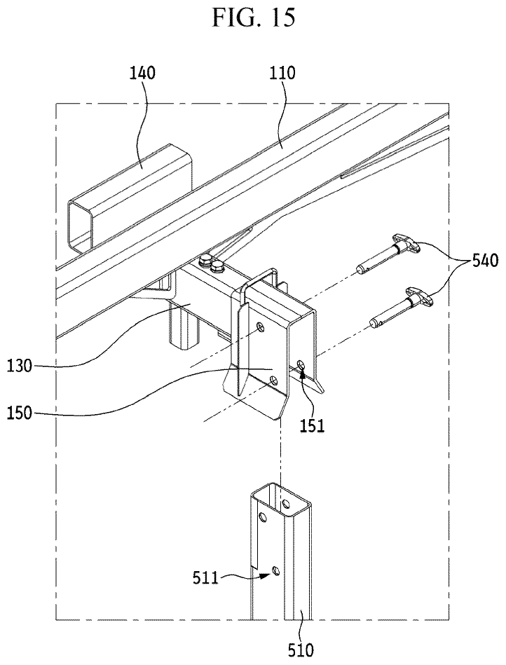

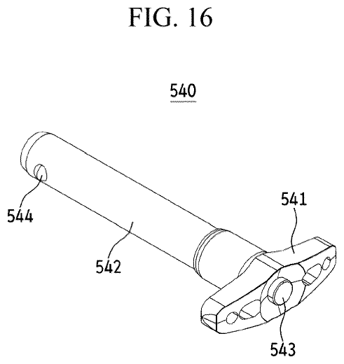

FIG. 14 is a perspective view illustrating the side support module of the track attachment and detachment apparatus of FIG. 2, FIG. 15 is a reference diagram illustrating the process of coupling the side support module to the upper support module of the track attachment and detachment apparatus of FIG. 14, and FIG. 16 is a perspective view illustrating a release pin connecting the side support module to the upper support module of the track attachment and detachment apparatus of FIG. 15.

Referring to FIGS. 14 through 16, the side support module 500 may include a vertical frame 510 and a fastening frame 520.

The vertical frame 510 may connect the upper support module 100 and the lower support module 200 in a vertical direction and may provide a function of maintaining the gap between the upper support module 100 and the lower support module 200. The upper end of the vertical frame 510 may be inserted into and thereby connected to the fifth frame 150 of the upper support module 100.

At the lower end of the vertical frame 510, the fastening frame 520 may be arranged (e.g., may extend) parallel to the sixth frames 210 of the lower support module 200 and coupled to the sixth frames 210.

The side support module 500 may further include a reinforcing frame 530 that connects the vertical frame 510 to the edge frame 411, or the vertical frame 510 and the leading end of the fastening frame 520.

When the upper end of the vertical frame 510 is inserted into the fifth frame 150, the vertical frame 510 and the fifth frame 150 may be coupled through release pins 540.

The release pins 540 may be coupled in a direction perpendicular to the insertion direction of the vertical frame 510 into the fifth frame 150. The fifth frame 150 and the vertical frame 510 may be provided with fastening holes 151 and fastening holes 511, respectively, into which the release pins 540 are inserted.

Each of the release pins 540 may include a handle part 541 gripped by the user and an insertion part 542 that passes through fastening holes 151 and 511 to prevent the vertical frame 510 from being removed from the fifth frame 150.

A push switch 543 may be provided on the handle part 541. In addition, a protrusion 544 may be provided on the outer circumferential surface near the leading end of the insertion part 542. The protrusion 544 may protrude outward from the outer circumferential surface of the insertion part 542 after passing through the fastening holes 151 and 511 and being exposed to the outside of the fifth frame 150.

When the push switch 543 is pressed, the protrusion 544 may retract inward from the outer circumferential surface of the insertion part 542. When the push switch 543 is released, the protrusion 544 may protrude outward from the outer circumferential surface of the insertion part 542.

Accordingly, when the fifth frame 150 and the vertical frame 510 are aligned, the release pins 540 may pass through the pairs of fastening holes 151 and 511 with the push switches 543 pressed, and may then be released to couple the fifth frame 150 and the vertical frame 510. The release pins 540 may be removed from the pairs of fastening holes 151 and 511 with the push switches 543, and then the push switches 543 may be released. The release pins 540 may not be removed from the pairs of fastening holes 151 and 511 without pressing the push switches 543.

Therefore, the track attachment and detachment apparatus according to an embodiment of the present disclosure allows tracks to be attached and detached quickly with minimal personnel and equipment. By configuring the track attachment and detachment apparatus as an assembly structure, it can be loaded onto a single vehicle, enabling rapid maintenance and repair regardless of the maintenance location. Additionally, the track attachment and detachment apparatus enables the strong pressure locking the track around the drive wheel to be quickly released.

While non-limiting example embodiments of the present disclosure have been described above with reference to the accompanying drawings, embodiments of the present disclosure are not limited to the specific configurations and operations described above. Various modifications may be implemented without departing from the scope of the present disclosure. Therefore, such modifications should be considered to fall within the scope of the present disclosure.

What is claimed is:

1. A track attachment and detachment apparatus comprising:
an upper support configured to support a lower part of an upper region of a track of a vehicle, the lower part of the upper region of the track being above the upper support;
a lower support configured to support a lower part of a lower region of the track while extending in parallel to the upper support;
a plurality of side supports configured to maintain a gap between the upper support and the lower support;
a first angle adjuster configured to support a first inclined portion of the track while the first angle adjuster has a first inclination angle from the lower support toward the upper support, the first angle adjuster further configured to selectively set the first inclination angle to correspond to a side of a drive wheel of the vehicle, the drive wheel configured to receive a first driving force of the vehicle; and
a first presser configured to press the track in a first pressing direction toward the drive wheel from the upper support such that the track is separated from the drive wheel.

2. The track attachment and detachment apparatus of claim 1, wherein the first angle adjuster comprises:
a support frame extending along a longitudinal direction of the lower support at a first side of the lower support;
a rotating frame, wherein a first end of the rotating frame is configured to be hinge-coupled to the support frame and a second end of the rotating frame is configured to rotate to correspond to an inclination angle of the track; and
an angle adjuster configured to be connected to and between the support frame and the second end of the rotating frame, and vary in length to adjust an inclination angle of the rotating frame.

3. The track attachment and detachment apparatus of claim 2, wherein the first angle adjuster further comprises a friction contact between the rotating frame and the first inclined portion of the track,
wherein the friction contact is configured to make frictional contact with an outer surface of the track.

4. The track attachment and detachment apparatus of claim 3, wherein the friction contact comprises:
a fixing plate configured to be fixed to an upper surface of the rotating frame; and
a plurality of friction patterns protruding from the fixing plate and configured to be respectively inserted into a plurality of treads on the outer surface of the track.

5. The track attachment and detachment apparatus of claim 4, wherein the first angle adjuster further comprises a spacing adjuster configured to slide the fixing plate relative to the rotating frame along a longitudinal direction of the rotating frame.

6. The track attachment and detachment apparatus of claim 2, wherein the first angle adjuster further comprises an inclination angle indicator that indicates an inclination angle set for a type of the vehicle.

7. The track attachment and detachment apparatus of claim 4, wherein the first presser comprises:
a moving frame configured to be inserted into, and slidably movable within, a first end of the upper support;
a driver at the first end of the upper support and configured to provide a second driving force that causes the moving frame to move linearly back and forth; and
a head unit comprising an adjustment bar, the head unit being at a leading end of the moving frame, and the adjustment bar protruding in a direction perpendicular to the moving frame, the adjustment bar configured to physically interact with a guide lug at an inner center of the track.

8. The track attachment and detachment apparatus of claim 7, wherein the first presser is configured to separate the track from the drive wheel by pressing the track in a direction toward the drive wheel.

9. The track attachment and detachment apparatus of claim 7, wherein a cross-section of the adjustment bar comprises a circular shape or a polygonal shape.

10. The track attachment and detachment apparatus of claim 7, wherein the first presser further comprises a guide between the moving frame and the first end of the upper support, the guide configured to guide sliding movement of the moving frame.

11. The track attachment and detachment apparatus of claim 10, wherein the guide comprises:
a guide rail, wherein a first side of the guide rail, perpendicular to an extending direction of the guide rail, faces towards the moving frame; and
a block coupled to a second side of the guide rail, opposite to the first side of the guide rail, wherein the block is configured to enable rolling movement of the guide rail.

12. The track attachment and detachment apparatus of claim 7, wherein the driver comprises:
a screw shaft, wherein an end of the screw shaft is configured to be connected to a lower part of the moving frame to move the moving frame linearly;
a case at the first end of the upper support, the case configured to allow the screw shaft to move linearly in and out of the case due to a rotational force; and
a handle configured to input the rotational force to the case, based on a user interacting with the handle.

13. The track attachment and detachment apparatus of claim 7, further comprising:
a second presser configured to provide a pressing force to the track in a direction opposite to the first pressing direction.

14. The track attachment and detachment apparatus of claim 2, further comprising:
a second angle adjuster configured to support a second inclined portion of the track while the second angle adjuster has a second inclination angle from the lower support toward the upper support, the second angle adjuster further configured to selectively set the second inclination angle to correspond to a side of an idler wheel of the vehicle,
wherein the drive wheel is at a first side of the track, and the idler wheel is at a second side of the track, opposite to the first side of the track.

15. The track attachment and detachment apparatus of claim 1, wherein the upper support comprises:
a first frame configured to support the track in a first support groove of the track while the first frame extends along a longitudinal direction of the track, the first support groove being between a guide lug of the track and a first drive lug of the track;
a second frame that extends parallel the first frame below the first frame;
a pair of fork frames that extend between the first frame and the second frame, in a direction perpendicular to the longitudinal direction of the track, the pair of fork frames configured to receive forks of a forklift; and
at least one auxiliary support structure that comprises:
a third frame that extends perpendicular to the first frame, between the first frame, the second frame, and the pair of fork frames;
a fourth frame that extends parallel to the first frame at a first side of the third frame, the fourth frame configured to support the track in a second support groove of the track, the second support groove being between the guide lug and a second drive lug of the track; and
a fifth frame coupled to an upper end of one of the plurality of side supports at a second side of the third frame, opposite to the first side of the third frame.

16. The track attachment and detachment apparatus of claim 15, wherein the upper support further comprises a release pin configured to detachably couple the fifth frame and the one of the plurality of side supports.

17. The track attachment and detachment apparatus of claim 15, wherein the upper support further comprises a first extension frame and a second extension frame that are configured to be connected to respective ends of the first frame such that the first frame, the first extension frame, and the second extension frame are at a same height.

18. The track attachment and detachment apparatus of claim 17, wherein the first presser is configured to be detachably connected to a leading end of the first extension frame at a first side of the first frame,
wherein the track attachment and detachment apparatus further comprises a second presser configured to provide a pressing force to the track in a second pressing direction opposite to the first pressing direction, wherein the second presser is configured to be detachably connected to a leading end of the second extension frame at a second side of the first frame, opposite to the first side of the first frame, and
wherein the at least one auxiliary support structure comprises:
a first auxiliary support structure connected to the first extension frame; and
a second auxiliary support structure connected to the second extension frame.

19. The track attachment and detachment apparatus of claim 1, wherein the lower support comprises:
sixth frames arranged along a longitudinal direction of the track to support a lower side of the lower region of the track; and
seventh frames below the sixth frames, the seventh frames extending in a direction perpendicular to the sixth frames.

20. The track attachment and detachment apparatus of claim 19, wherein the lower support further comprises:
a first unit support structure comprising a first set of the sixth frames and a first set of the seventh frames, the first unit support structure configured to be on a first side of the lower region of the track; and
a second unit support structure comprising a second set of the sixth frames and a second set of the seventh frames, the second unit support structure on a second side of the lower region of the track, opposite to the first side of the lower region of the track, and
wherein the first unit support structure and the second unit support structure are configured to be detachably coupled to each other.
